(19) United States
(12) Patent Application Publication
(10) Pub. No.: US 2015/0010802 A1
(43) Pub. Date: Jan. 8, 2015

(54) BATTERY TEMPERATURE ADJUSTMENT APPARATUS

(71) Applicant: DENSO CORPORATION, Kariya-city (JP)

(72) Inventor: Yoshimitsu INOUE, Chiryu-shi (JP)

(21) Appl. No.: 14/321,076

(22) Filed: Jul. 1, 2014

(30) Foreign Application Priority Data
Jul. 4, 2013 (JP) 2013-141028

(51) Int. Cl. H01M 10/655

(52) U.S. Cl. CPC H01M 10/5044
USPC 429/120

(57) ABSTRACT

A battery temperature adjustment apparatus includes a case for housing battery cells and a fan device disposed in the case for blowing air to cool the battery cells. The battery temperature adjustment apparatus further includes a circulation passage formed inside the case, the air blown from the fan device being sucked into the fan device after having circulated through the circulation passage and exchanged heat with the battery cells, a discharge passage which makes communication between inside and outside of the case, a first inflow passage which constitutes part of the circulation passage and through which the air having exchanged heat with the battery cells is sucked into the fan device, a second inflow passage which makes communication between inside and outside of the case, and an air distribution permitting/inhibiting device which permits and inhibits air distribution through at least one of the discharge passage and the second inflow passage.

This application claims priority to Japanese Patent Application No. 2013-141028 filed on Jul. 4, 2013, the entire contents of which are hereby incorporated by reference.

### BACKGROUND OF THE INVENTION

1. Field of the Invention

The present invention relates to a battery temperature adjustment apparatus for battery cells housed in a case.

2. Description of Related Art

There is known a battery temperature adjustment apparatus for adjusting the temperature of batteries. For example, refer to Japanese Patent Application Laid-open No. 2010-50000 (Patent document 1) and Japanese Patent Application Laid-open No. 2004-288527 (Patent document 2).

The battery temperature adjustment apparatus described in patent document 1 includes a cooling plate disposed so as to be in contact with a battery block of battery cells. The cooling plate has a hollow part which is filled with cooling liquid, and is provided with a heat exchanger. The heat exchanger is connected with a coolant passage through which a coolant is supplied. The heat exchanger is cooled by the vaporization heat of the coolant to cool the cooling liquid so that the battery cells are cooled by the cooling plate.

The battery temperature adjustment apparatus described in Patent document 2 includes a battery assembly having a heat transfer medium passage for passing a heat transfer medium between single batteries, a feed device for feeding the heat transfer medium, a feed passage for supplying the heat transfer medium to the heat transfer medium passage, and a discharge passage for discharging the heat transfer medium from the heat transfer medium passage. The battery assembly, feed device, feed passage and discharge passage are provided in a case. The heat transfer medium fed by the feed device flows through the feed passage, heat transfer medium passage and discharge passage in this order, and returns to the feed device. The heat transfer medium flows through a closed circuit while cooling the single batteries.

However, the battery temperature adjustment apparatus described in Patent document 1 has a problem in that since the batteries are cooled by the vaporization heat of the coolant using refrigeration cycle equipment, the manufacturing cost is high. In a case where the refrigeration cycle equipment is housed in the case that houses the batteries, since a tube for passing the coolant has to be provided inside the case, the manufacturing cost further increases.

The battery temperature adjustment apparatus described in Patent document 2 has the structure in which the batteries are disposed in a closed space within the case so that the temperature of the batteries can be adjusted by circulating the heat transfer medium in a closed circuit. Accordingly, since heat dissipation from inside the case to outside the case is performed only by natural convection of the circulating heat transfer medium, it is difficult to sufficiently cool the batteries. If the battery temperature adjustment apparatus described in Patent document 2 is modified to employ a non-circulation method in which the batteries housed in the case are cooled by air sucked from outside the case, and the air having cooled the batteries is discharged to outside the case, there arises another problem that noise easily propagates to the outside because a lot of air distributes between the inside and outside of the case. Further, dust can easily enter the case, and dew condensation easily occurs inside the case. In addition, it is necessary to take measures of reducing effects of the flow of discharged air on the ambient environment.

### SUMMARY

An exemplary embodiment provides a battery temperature adjustment apparatus including:

a case for housing battery cells;

a fan device disposed in the case for blowing air to cool the battery cells;

a circulation passage formed inside the case, the air blown from the fan device being sucked into the fan device after having circulated through the circulation passage and exchanged heat with the battery cells;

a discharge passage which makes communication between inside and outside of the case, part of the air circulating through the circulation passage being discharged after having exchanged heat with the battery cells;

a first inflow passage which constitutes part of the circulation passage, and through which the air having exchanged heat with the battery cells is sucked into the fan device;

a second inflow passage which makes communication between inside and outside of the case to allow air outside the case to flow therethrough; and

an air distribution permitting/inhibiting device which permits and inhibits air distribution through at least one of the discharge passage and the second inflow passage.

According to the exemplary embodiment, there is provided a battery temperature adjustment apparatus capable of adjusting the temperature of batteries housed in a case with less noise without requiring a complicated refrigeration cycle equipment.

Other advantages and features of the invention will become apparent from the following description including the drawings and claims.

### BRIEF DESCRIPTION OF THE DRAWINGS

In the accompanying drawings:

FIG. 1 is a diagram for explaining flow of air for battery cooling in a battery temperature adjustment apparatus according to a first embodiment of the invention; and

FIG. 2 is a control diagram in accordance with which the valve opening position of an on-off valve and the output of a fan device are controlled depending on the cell temperature in the battery temperature adjustment apparatus according to the first embodiment of the invention; and

FIG. 3 is a diagram for explaining flow of air for battery cooling in a battery temperature adjustment apparatus according to a second embodiment of the invention.

### PREFERRED EMBODIMENTS OF THE INVENTION

In the below described embodiments, parts or components which are the same or equivalent to those described in the preceding embodiments may be designated by the same reference numerals or characters. In the below described embodiments, when only part of the entire structure is explained, descriptions of the preceding embodiments can be referred to for the other parts. It should be noted that two or more of the below described embodiments can be combined when there is a statement to that effect, or if no substantive obstacle is expected in the combination.

### First Embodiment

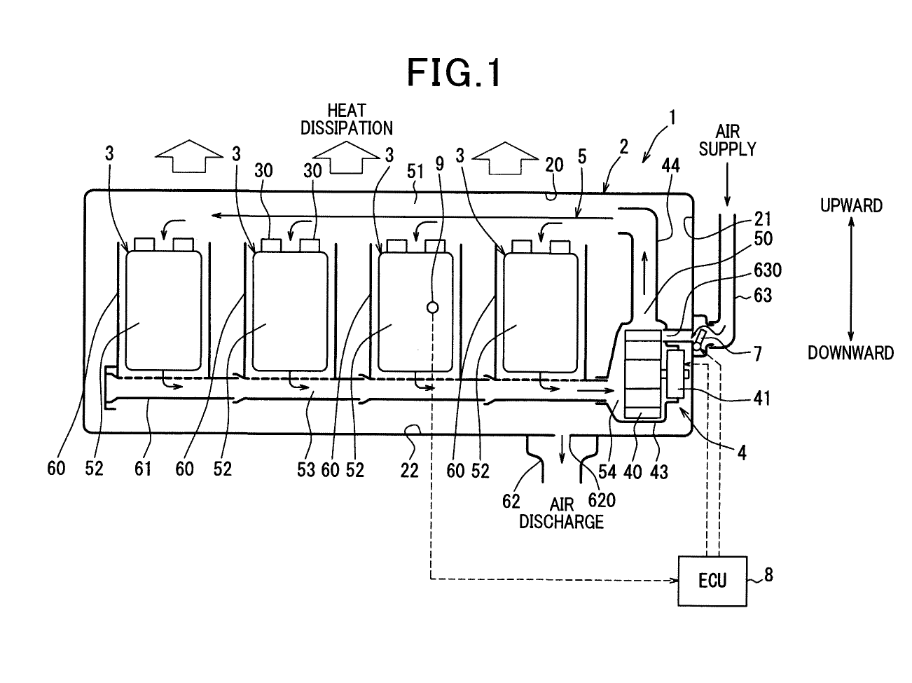

FIG. 1 is a diagram showing flow of air for battery cooling in a battery temperature adjustment apparatus 1 according to a first embodiment of the invention together with the structure of the battery temperature adjustment apparatus 1. The battery temperature adjustment apparatus 1 is used for a hybrid vehicle which uses, as a vehicle driving engine, a combination of an internal combustion engine and an electric motor powered by batteries, or an electric vehicle which uses as a vehicle driving engine, an electric motor powered by batteries, for example. The battery temperature adjustment apparatus 1 includes a case 2 housing battery cells 3 which may be nickel hydrogen rechargeable batteries, rechargeable lithium-ion batteries, or organic radical batteries, for example.

The case 2 houses also a fan device 4. The battery cells 3 are connected in series and stacked on one another. Inside the case 2, there is formed a circulation passage 5 through which the fan device 4 forcibly blows air. The circulation passage 5 is a passage which allows the air blown from the fan device 4 to flow to exchange heat with the battery cells 3 and thereafter be sucked into the fan device 4. As shown in FIG. 1, the circulation passage 5 is constituted of a first inflow passage 54, a blowoff passage 50, a top plate side passage 51, battery passages 52 and a collective passage 53.

Charging, discharging and temperature adjustment of the battery cells 3 are controlled by an electronic component (not shown). This electronic component may be a DC/DC converter, a motor for driving a fan member, or a component controlled by an inverter. This electronic component may be housed in the cover 2. This electronic component may be disposed in the circulation passage 5 so that it can be cooled by the circulating air together with the battery cells 3. Further, the case 2 may house therein a cell monitoring unit for monitoring at least the voltage and temperature of the battery cells 3, a junction box and a service plug.

The case 2, which has a box shape having at least six wall surfaces, is formed as a molded article made of an aluminum or steel plate, for example. The case 2 may be fabricated by assembling case members so as to form a box-shaped inner space therein. At least one of the wall surfaces constituting the case 2 may be formed with concaves and convexes to increase the heat dissipating area.

The battery cells 3 form cell stacks within the inner space of the case 2. As shown in FIG. 1, the cell stacks are arranged with a regular spacing in a state of being surrounded by their battery cases 60 within the inner space of the case 2. Each battery case 60 opens to the inner space of the case 2 at the side of a top plate 20 of the case 2, and connected to a collective duct 61 at the side of a bottom plate 22 of the case 2.

Accordingly, the passages which are located inside the respective battery cases 60 and constitute part of the circulation passage 5 include independent entrances located at the side of the top plate 20, and include exits which connect to the collective passage 53 at the side of the bottom plate 22. The collective passage 53 extends along the bottom plate 22 to the inlet of a casing 43 under the cell stacks arranged with the regular spacing, and connects to the first inflow passage 54. The first inflow passage 54, which is part of the circulation passage 5, is provided inside the case 2 to suck the air having exchanged heat with the battery cells 3.

Accordingly, the air blown from the fan device 4 and reaching the top plate side passage 51 flows into the battery passages 52 from the upper entrances of the battery cases 60. The battery passages 52 may be inter-cell passages between respective adjacent two of the battery cells 3. The top plate side passage 51 is a passage located between the top plate 20 and the battery cells 3. The air flowing through the battery passages 52 absorbs heat from the outer surfaces of the battery cells 3 to cool the battery cells 3. The air having cooled the battery cells 3 and flowing from the exits of the battery cases 60 is collected in the collective passage 53 within the collective duct 61, and sucked into the fan device 4 through the first inflow passage 54. In this embodiment, the outer package surfaces of the battery cells 3 serve as one of heat dissipating device.

Further, the air also contacts electrode terminals 30 including positive and negative terminals of the battery cells 30 and bus bars for electrical connection between the positive and negative terminals. Accordingly, the electrode terminals 30 and the bus bars constitute one of the heat dissipating devices. In each battery case 60, the electrode terminals 30 and the bus bars are located at the upper side, that is, the upstream side of the airflow.

The fan device 4 is one example of an air blowing device for circulating air through the circulation passage 5 for cooling the battery cells 3. The fan device 4 includes a motor 41, a sirrocco fan 40 driven by the motor 41 and the casing 43 housing the sirrocco fan 40. The fan device 4 can be supplied with power from the battery cells 3. The casing 43 forms the first inflow passage 54 which is part of the circulation passage 5. Charging, discharging and temperature adjustment of the battery cells 3 are controlled by an electronic component (not shown).

In this embodiment, the fan device 4 is controlled by a control device 8 incorporated in the cell monitoring unit (not shown) disposed in the case 2. The battery cells 3 generate heat when charged or discharged. The cell monitoring unit includes a temperature sensor 9 which detects, as the cell temperature, the temperature of a predetermined one of the battery cells 3, and outputs an electrical signal indicating the detected temperature to the control device 8. The cell monitoring unit continuously monitors the cell temperature using the temperature sensor 9.

The first inflow passage 54, which extends in the rotation axis of the sirrocco fan 40, includes the inlet of the casing 43 through which the sirrocco fan 40 sucks air. As shown in FIG. 1, the sirrocco fan 40 is disposed at the lower side of the inner space of the case 2 so as to be close to a side plate 21 of the case 2. The motor 41 is located between the sideplate 21 and the sirrocco fan 40. The rotation axis of the sirrocco fan 40 is parallel to the top plate 20 of the case 2. The first inflow passage 54 is located at the side of the battery cells 3 with respect to the fan device 4 and connects to the collective passage 53. That is, the inlet of the casing 43 is connected to the collective duct 61 that forms the collective passage 53.

The casing 43 also forms the blowoff passage 50 which is part of the circulation passage 5. The blowoff passage 50 extends in the centrifugal direction of the sirrocco fan 40, that is in the direction perpendicular to the rotation axis of the sirrocco fan 40. The blowoff passage 50 is a passage extending in the direction perpendicular to the direction in which the first inflow passage 54 extends. Accordingly, the blowoff passage 50 extends upward within the inner space of the case 2. The outlet of the casing 43 is connected to a fan duct 44 extending upward. The fan duct 44 opens in the vicinity of the top plate 20 of the case 2. Accordingly, the blowoff passage 50 extends to the vicinity of the top plate 20 within the inner space of the case 2.

The circulation passage 5 is not exposed to any one of the wall surfaces of the case 2 at its part constituted of the fan duct 44, battery cases 60, collective duct 61 and the casing 43, but exposed to at least one of the wall surfaces of the case 2 at its part constituting the top plate side passage 51. The circulation passage 5 includes a passage part in which the air circulated in the case 2 by the fan device 4 flows while contacting at least one of the wall surfaces of the case 2.

The top plate 20 is one of the wall surfaces of the case 2 which the circulating air contacts, and the top side passage 51 is the passage part in which the circulating air flows while contacting the top plate 20. The air blown from the fan device 4, passing through the blowoff passage 50 and reaching the vicinity of the top plate 20 flows through the top side passage 51 after exchanging heat with the battery cells 3. This circulating air further flows through the top plate side passage 51 and flows into the battery passages 52 from the entrances of the respective battery cases 60 to exchange heat with the battery cells 30.

The circulating air dissipates heat absorbed from the battery cells 3 to outside the case 2 through the top plate 20 by natural convection. Accordingly, the entire of the top plate 20 serves as a heat dissipation surface for dissipating heat of the battery cells 3 housed in the case 2 to outside the case 2.

Preferably, the top plate 20 which the air circulating through the circulation passage 5 contacts at the time of flowing through the top plate side passage 51 is the wall surface having the largest surface area of all the wall surfaces of the case 2 so that the battery cells 30 can be cooled efficiently. When the case 2 has a rectangular shape and the wall surface having the largest surface area is two or more in number, one of them is the top plate 20.

In this embodiment, two inflow passages are provided for the fan device 4. One is the first inflow passage 54 and the other is a second inflow passage 630. The second inflow passage 630 is a passage for making communication between the fan device 4 and the outside of the case 2. The second inflow passage 630 is smaller in cross section than the first inflow passage 54. The second inflow passage 630 is the inner passage of a supply duct 63 connected to the back side part of the casing 43, which is located on the side opposite the inlet of the casing 43.

The supply duct 63 penetrates through the side plate 21 of the case 2 to make communication between the back side part of the casing 43 and the outside of the case 2. The second inflow passage 630 penetrates through one of the wall surfaces except the top plate 20, which the air circulating the circulation passage 5 contacts while passing through the top side passage 51.

The battery temperature adjustment apparatus 1 includes an air distribution permitting/inhibiting device for permitting and inhibiting air distribution through the second inflow passage 630. In this embodiment, the air distribution permitting/inhibiting device is an on-off valve 7 driven by power from the battery cells 3.

The on-off valve 7 is disposed in the supply duct 63 to open and close the second inflow passage 630 from outside the case 2. As shown in FIG. 1, the on-off valve 7 includes a door part whose angular position around its rotation axis is variable. Instead, the on-off valve 7 may include a door part which is slidable relative to the axis of the second inflow passage 630.

The operation of the on-off valve 7 is controlled by the control device 8. The control device 8 adjusts the angular position of the door part of the on-off valve 7 by controlling its driver such as a servo motor for driving the door part.

The supply duct 63 extends outside the case 2 upward along the side plate 21. The inlet end of the supply duct 63 from which air flows into the supply duct 63 is located at a height approximately the same as the height of the top plate 20. When the second inflow passage 630 is opened by the on-off valve 7 while the fan device 4 is in operation, the air sucked into the supply duct 63 is introduced into the circulation passage 5 through the second inflow passage 630, and taken into the inner space of the case 2. The battery temperature adjustment apparatus 1 includes a discharge passage 620 through which part of the air circulating in the case 102 leaks outside. The discharge passage 620 penetrates through the bottom plate 22 located under the collective duct 61 to make communication between the inside and outside of the case 2. The air outside the case 2 is sucked into the circulation passage 5 through the second inflow passage 630 by the suction force of the fan device 104 when the second inflow passage 630 is opened by the on-off valve 7.

The discharge passage 620 penetrates through one of the wall surfaces except the top plate 20 which the circulating air contacts at the time of passing through the top plate side passage 51. The discharge passage 620 is formed of a small-diameter hole penetrating through the case 2. Around this small-diameter hole, there is formed a ring portion thinner than any other portions of the case 2. The diameter of this small-diameter hole is set to such a value that the air inside the case 102 is not discharged through the discharge passage 620 as long the second inflow passage 630 is closed by the on-off valve 7 and the air inside the case 102 continues to circulate through the circulation passage 5. The discharge passage 620 may be the inner passage of a discharge duct 62 connected to the bottom plate 22.

The discharge passage 620 is located downstream of the battery passages 52 through which the air blown from the fan device 4 passes to exchange heat with the battery cells 3, and upstream of the first inflow passage 54. Accordingly, the discharge passage 620 is a passage that allows part of the air circulating through the circulation passage 5 to overflow after having exchanged heat with the battery cells 3. The amount of the air overflowing to outside the case 2 is the same as the amount of the air taken in from outside the case 2 through the second inflow passage 630. Accordingly, the inner space of the case 2 is a closed space except the discharge passage 620 and the second inflow passage 630.

The control device 8 controls the rotational speed of the fan device 4 and the valve opening position of the on-off valve 7 based on results of computations which an arithmetic section thereof executes using computation programs stored in a storage section thereof. The control device 8 also controls driving of the fan device 4 and driving of the on-off valve 7 in accordance with the cell temperature detected by the temperature sensor 9.

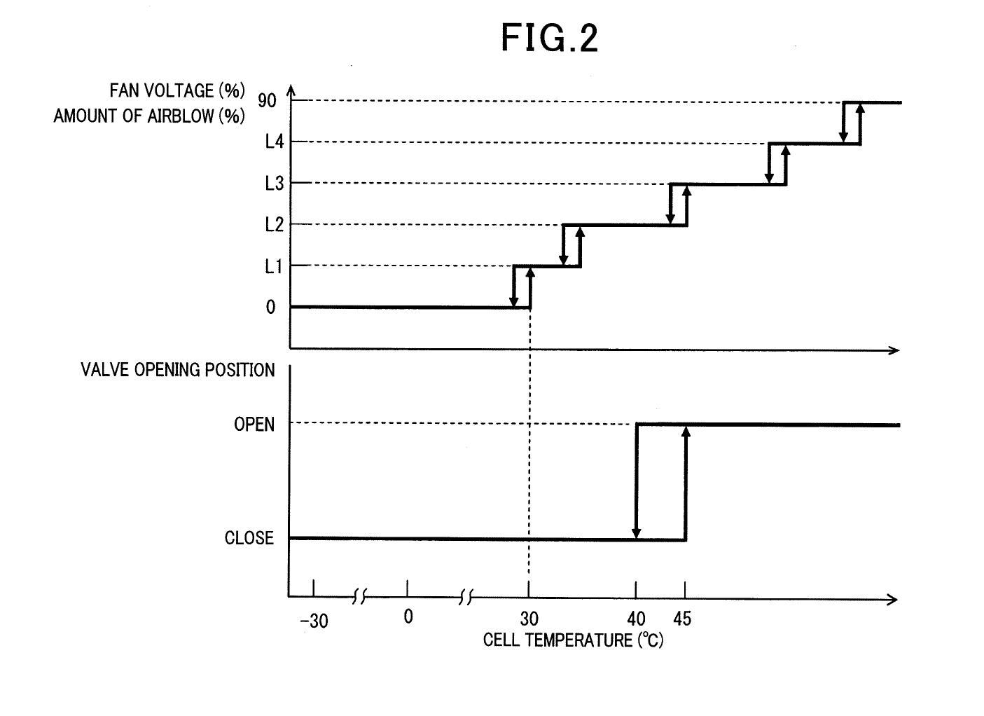

Next, how the control device 8 controls the fan device 4 and the on-off valve 7 is explained with reference to FIG. 2. FIG. 2 is a control diagram in accordance with which the valve opening position of the on-off valve 7 and the output of the fan device 4 are controlled depending on the cell temperature in the battery temperature adjustment apparatus 1.

The battery cells 3 generate heat when charged and discharged. To ensure the performance of the battery cells 3, the cell temperature has to be maintained in an appropriate temperature range. As shown in FIG. 2, when the cell temperature detected by the temperature sensor 9 is lower than 30° C., the control device 8 controls the on-off valve 7 to close the second inflow passage 630, and sets the voltage applied to the fan device 4 to 0 V. As a result, since the fan device 4 stops operation, no airflow occurs in the circulation passage 5. Accordingly, since the battery cells 3 are not cooled positively by cooling fluid, and the temperature of the inner space of the case 2 increases gradually to keep the inner space of the case 2 warm.

When the cell temperature is detected to exceed 30° C. thereafter, the control device 8 increases the fan voltage (the voltage applied to the fan device 4) to increase the duty ratio of the fan voltage to L1. In this embodiment, the duty ratio L1 is 18% of the maximum duty ratio corresponding to the maximum rated output of the fan device 4. Accordingly, the rate of the airflow by the fan device 4 becomes 18% of the maximum flow rate. Since a small amount of air starts to flow through the circulation passage 5, the battery cells 30 are cooled more than when the cell temperature is lower than 30° C.

Thereafter, if the cell temperature further increases, the control device 8 further increases the fan voltage to increase its duty ratio from L1 to L2 while keeping the second inflow passage 630 closed. In this embodiment, the duty ratio L2 is 36% of the maximum duty ratio. Accordingly, the rate of the airflow by the fan device 4 becomes 36% of the maximum flow rate.

Thereafter, if the cell temperature further increases, the control device 8 further increases the fan voltage to increase its duty ratio from L2 to L3 while controlling the valve opening position of the on-off valve 7 to open the second inflow passage 630. In this embodiment, the duty ratio L3 is 54% of the maximum duty ratio. Accordingly, the rate of the airflow by the fan device 4 becomes 54% of the maximum flow rate.

In this case, the air outside the case 2 is sucked into the circulation passage 5 through the second inflow passage 630, and circulates through the circulation passage 5 while part thereof leaking outside through the discharge passage 620. Accordingly, the battery cells 3 are cooled by the circulating air, while the heat absorbed from the battery cells 3 is dissipated to outside the case 2 and the outside air is taken into the case 2 to efficiently cool the battery cells 3.

If the battery cells 3 generate heat more than the heat dissipated to outside the case 2, the cell temperature further increases thereafter. In this case, the control device 8 further increases the fan voltage to increase its duty ratio from L3 to L4 (and L5 as necessary) while keeping the second inflow passage 630 open to further increase the amount of the air circulation, the amount of the air supply and the amount of the air discharge to thereby further increase the amount of the heat absorption from the battery cells 3. In this embodiment, the duty ratio L4 is set larger than 60 and smaller than 90% of the maximum duty ratio and the duty ratio L5 is 90% of the maximum duty ratio.

In the above, the way the control device 8 controls the fan device 4 and the on-off valve 7 when the cell temperature is increasing has been explained. When the cell temperature is decreasing, the control device 8 controls the fan device 4 and the on-off valve 7 in a way similar to the way described above as described below. When the cell temperature falls below 40° C., the on-off valve 7 is controlled to change the second inflow-passage 630 from the open state to the closed state. The fan voltage is controlled to decrease so that its duty ratio is reduced stepwise from L5 to L1 with the decrease of the cell temperature. When the cell temperature falls below 30° C., the fan voltage is set to 0 V to stop the fan device 4. There is a difference in the threshold temperatures to change control on the on-off valve 7 and the fan device 4 between when the cell temperature is increasing and when the cell temperature is decreasing. This is for preventing hunting of the on-off valve 7 and the fan device 4 due to variation of the cell temperature.

In this embodiment, the air distribution permission temperature above which the on-off valve 7 is allowed to open the second inflow passage 630 is set to 45° C. or 40° C. The air distribution permission temperature is set lower than the warranty-period guarantee temperature of the battery cells 3 below which the warranty period is guaranteed.

The battery temperature adjustment apparatus 1 according to the first embodiment of the invention provides the following advantages. The battery temperature adjustment apparatus 1 includes the battery cells 3, the fan device 4, the air circulation passage 5 formed inside the case 2, and the discharge passage 620 which allows part of the air circulating through the circulation passage 5 to leak outside the case 2 after having exchanged heat with the battery cells 3. The battery temperature adjustment apparatus 1 includes also the first inflow passage 54 which is part of the circulation passage 5 and through which the air having exchanged heat with the battery cells 3 is sucked into the fan device 4, and the second inflow passage 630 which makes communication between the outside and inside of the case 2 to allow the air outside the case 2 to flow therethrough. Further, the battery temperature adjustment apparatus 1 include the on-off valve 7 as the air distribution permitting/inhibiting device for permitting and inhibiting air distribution through at least one of the discharge passage 620 and the second inflow passage 630.

Accordingly, the battery cells 3 can be cooled by the air allowed to be distributed by the on-off valve 7, while dissipating the heat absorbed from the battery cells 3 to outside the case 2 and taking in the fresh air from outside the case 2 to enable forming an airflow for efficiently cooling the battery cells 3. The battery temperature adjustment apparatus 1 according to this embodiment can ensure an airflow strong enough to absorb a sufficient amount of the heat from the battery cells 3, while sufficiently suppressing noise from transmitting to outside the case 2 compared to conventional cooling apparatuses in which a large amount of cooling air is taking in and discharged.

When the on-off valve 7 permits the air distribution, the fresh air outside the case 2 is sucked into the circulation passage 5 through the second inflow passage 630, and an amount of the air inside the case 2 equivalent to the amount of the air sucked into the circulation passage 5 is discharged from the discharge passage 620. Accordingly, the battery cells 3 can be cooled by the circulating air, while dissipating the heat absorbed from the battery cells 3 to outside the case 2 and taking in the fresh air from outside the case 2 to efficiently cool the battery cells 3.

When the cell temperature is sufficiently low, the on-off valve 7 inhibits the air distribution to suppress noise transmission to outside the case 2 and also suppress the heat dissipation to keep the inside of the case 2 warm. This makes it possible to rapidly warm up the battery cells 3 so that they can output sufficient power early.

Since the circulation passage 5 provided in the case 2 is surrounded by the walls constituting the case 2, it is possible to use the walls of the case 2 as a heat dissipating medium for promoting heat dissipation to outside the case 2. That is, according to this embodiment, it is possible to form a heat transfer path for effectively exhausting the heat from the battery cells 3 to outside the case 2. Hence, according to this embodiment, it is possible to use entire of the walls of the case 2 as a heat dissipating area to effectively cool the battery cells 3.

The on-off valve 7 closes the second inflow passage 630 to inhibit the air distribution when the cell temperature or a temperature relevant to the cell temperature is lower than the air distribution permission temperature (45° C., for example). This makes it possible to maintain the cell temperature within an appropriate temperature range by suppressing the battery cooling.

The fan device 4 doe not start until the cell temperature or the temperature relevant to the cell temperature exceeds a predetermined operation starting temperature (30° C., for example) set lower than the air distribution permission temperature (45° C., for example). Accordingly, the fan device 4 does not operate as long as the cell temperature or the relevant temperature is lower than the operation starting temperature.

Accordingly, when the cell temperature is sufficiently low, since the air distribution is inhibited by the on-off valve 7, noise transmission to outside the case 2 can be suppressed. Further, since the fan device 4 does not operate and air circulation is not formed in the case 2, the air inside the case 2 is not agitated. Accordingly, it is possible to suppress the heat dissipation from the wall surfaces of the case 2 to keep the inside of the case 2 warm. This makes it possible to rapidly warm up the battery cells 3 so that they can output sufficient power early.

The fan device 4 is controlled such that the amount of air blow when the cell temperature or the relevant temperature exceeds the operation starting temperature causing the fan device 4 to start is smaller than the amount of air blow when the on-off valve 7 opens the second inflow passage 630 to permit the air distribution.

This makes it possible to suppress agitation of the air inside the case 2 at the time of start of the fan device 4 when the cell temperature or the relevant temperature is sufficiently low, to thereby prevent the battery cells 3 from being cooled excessively. Hence, according to this embodiment, it possible to rapidly warm up the battery cells 3 after a certain period of rest so that they can output sufficient power early. Further, since the amount of air blown is suppressed when the fan device 4 starts to operate, noise transmission to outside the case 2 can be suppressed.

The case 2 of the battery temperature adjustment apparatus 1 is not formed with a large-diameter inlet hole or a large-diameter outlet hole, and accordingly noise can be prevented from transmitted to outside the case 2 when the air inside the case 2 is discharged. That is, the noise of the fan device 4 can be suppressed from being emitted to the outside. It is also possible to ensure air circulation enough to sufficiently absorb the heat from the battery cells 3, and to increase the efficiency of the heat absorption by agitating the air inside the case 2.

The circulation passage 5 provided in the case 2 is surrounded by the wall surfaces of the case 2. Since the wall surfaces surrounding the circulation passage 5 are used as a heat dissipation medium, the heat dissipation surface can be made large easily to promote heat dissipation to outside the case 2. That is, it is possible to form a heat transfer path for effectively exhausting the heat from the battery cells 3 to outside the case 2. Hence, according to this embodiment, it is possible to use entire of the wall surfaces of the case 2 as a heat dissipating area to effectively cool the battery cells.

When the on-off valve 7 permits the air distribution, the fresh air outside the case 2 is sucked into the circulation passage 5 through the second inflow passage 630, and an amount of the air inside the case 2 equivalent to the amount of the air sucked into the circulation passage 5 is discharged from the discharge passage 620. Accordingly, the battery cells 3 can be cooled by the circulating air, while dissipating the heat accumulated in the air to outside the case 2 and taking in the fresh air from outside the case 2 to ensure efficient heat absorption. Hence, the battery temperature adjustment apparatus 1 can satisfy both the noise suppression and effective cooling of the battery cells 3 without requiring a complicated refrigeration cycle equipment unlike conventional battery cooling apparatuses.

The discharge passage 620 is located downstream of the battery passages 52 through which the air blown from the fan device 4 passes to exchange heat with the battery cells, and upstream of the first inflow passage 54. This structural configuration enables reliably discharging the air having exchanged heat with the battery cells 3 and increased in temperature to the outside from the discharge passage 620 so that the heat accumulated in the case 2 by continuous heat absorption by the continuous air circulation can be exhausted to the outside reliably.

The circulation passage 5 includes the passage part (the top plate side passage 51, for example) in which the air circulating in the case 2 flows while contacting at least one of the wall surfaces of the case 2 (the top plate 20, for example). According to this structural configuration, since the top plate side passage 51, for example, constitutes part of circulation passage 5, it is possible to dissipate heat to outside the case 2 through the top plate 20 when the circulating air flows through the top plate side passage 51. As explained above, since at least one of the wall surfaces of the case 2 can be used as a heat dissipation medium, it is possible to structure a heat transfer path for effectively exhausting the heat from the battery cells 3 to outside the case 2.

The discharge passage 620 penetrates through one of the wall surfaces (bottom plate 22, for example) except the wall surface which the circulating air contacts while passing through the passage part (top plate side passage 51, for example). In this structure, heat dissipation from the case 2 is performed at the top plate 20 as a heat dissipation surface, and air discharge from the discharge passage 620 is performed at one of the other wall surfaces. Accordingly, since the wall surface for promoting heat dissipation is distinguished from the wall surface for performing air discharge, the case 2 can be installed appropriately conforming to its ambient environment.

The second inflow passage 630 penetrates through one of the wall surfaces (side plate 21, for example) except the wall surface which the circulating air contacts when passing through the passage part (top plate side passage 51, for example).

According to this structural configuration, heat dissipation is performed at the top plate 20 as a heat dissipation surface of the case 2, and fresh air introduction through the second inflow passage 630 is performed at one of the other wall surfaces. Accordingly, since the wall surface for promoting heat dissipation is not the wall surface for performing fresh air introduction, the case 2 can be installed appropriately conforming to its ambient environment. If the second inflow passage 630 was provided in the heat dissipation surface, the discharged air would sucked in again, causing the heat absorbed from the battery cells 3 to return to the circulation passage 5.

Preferably, the wall surface which the circulating air contacts when passing through the passage part (top plate side passage 51, for example) is the one (top plate 20, for example) having the largest surface area of all the wall surfaces of the case 2, so that the heat dissipation efficiency can be made high to efficiently cool the battery cells 3. The wall surface having the largest surface area of the case 2 may be two or more in number.

Preferably, the wall surface which the circulating air contacts when passing through the passage part (top plate side passage 51, for example) is the one (top plate 20, for example) which is located upward of the case 2 and perpendicular to the side plate 21.

According to the findings of the inventors of the present invention, heat dissipation to outside the case 2 is made partially by heat radiation through the air flowing through the circulating passage 5 and the wall surfaces of the case 2. Further, according to the findings of the inventors, the heat dissipation to outside the case 2 by the heat radiation is prominent at the wall surface located upward of the case 2. Accordingly, by causing the air circulating through the circulation passage 5 to contact the upper wall surface of the case 2 (top plate 20, for example), the heat dissipation by the heat radiation can be promoted.

Preferably, the second inflow passage 630 extends from the fan device 4 to the vehicle cabin to make communication between fan device 4 and the vehicle cabin. In this case, the air in the vehicle cabin can be introduced into the circulation passage 5 through the second inflow passage 630 to cool the battery cells 30 using the air in the air-conditioned vehicle cabin. For example, when the case 2 is installed in an environment higher in temperature than the vehicle cabin, the efficiency of absorbing the heat from the battery cells 3 can be maintained high because the air whose temperature is lower than the ambient temperature can be introduced into the case 2.

### Second Embodiment

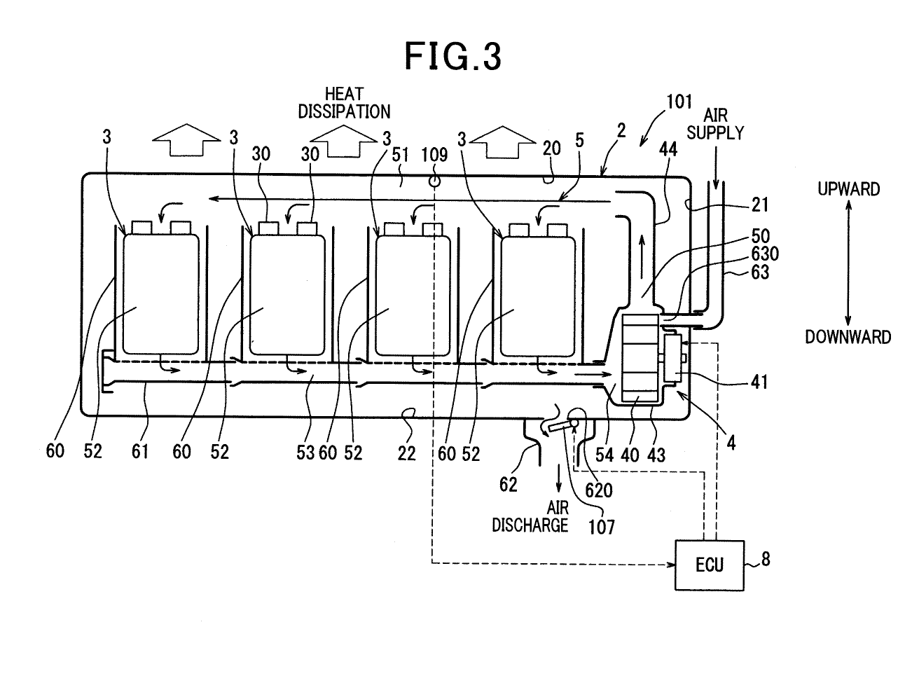

Next, a battery temperature adjustment apparatus 101 according to a second embodiment of the invention is described with reference to FIG. 3 with a focus on differences with the first embodiment. The components or parts shown in FIG. 3 which are the same as or equivalent to those shown in FIG. 1 are indicated by the same reference numerals or characters.

The battery temperature adjustment apparatus 101 includes an air distribution permitting/inhibiting device for permitting and inhibiting an air distribution through the discharge passage 620. In this embodiment, the air distribution permitting/inhibiting device is an on-off valve 107 driven by power from the battery cells 3.

The cell monitoring unit includes a temperature sensor 109 which detects the temperature of the top plate 20, and outputs an electrical signal indicating the detected temperature to the control device 8. The cell monitoring unit continuously monitors the temperature of the top plate 20 as a relevant temperature (the temperature relevant to the cell temperature) using the temperature sensor 109.

The control device 8 controls the rotational speed of the fan device 4 and the valve opening position of the on-off valve 107 based on results of computations which an arithmetic section thereof executes using computation programs stored in a storage section thereof. The control device 8 also controls driving of the fan device 4 and driving of the on-off valve 107 in accordance with the temperature of the top plate 20 detected by the temperature sensor 109.

The explanation for the control by the control device 8 of the first embodiment made in the foregoing with reference FIG. 2 can be applied to the control by the control device 8 of the second embodiment by replacing “temperature sensor 9” with “temperature sensor 109” and replacing “temperature of the battery cells 3” and “cell temperature” with the “temperature of the top plate 20”. The on-off valve 107 is disposed in the discharge duct 62 to open and close the second inflow passage 620 from outside the case 2. As shown in FIG. 3, the on-off valve 107 includes a door part whose angular position around its rotation axis is variable. When the on-off valve 107 opens the discharge passage 620 while the fan device 4 is in operation, the air sucked into the supply duct 63 is introduced into the circulation passage 5 through the second inflow passage 630. The air circulates through the circulation passage 5, while part thereof leaking outside through the discharge passage 620.

The on-off valve 107 may include a door part which is slidable relative to the axis of the second inflow passage 620 instead of the door part whose angular position around its rotation axis is variable.

The operation of the on-off valve 107 is controlled by the control device 8. The control device 8 adjusts the angular position of the door part of the on-off valve 107 by controlling its driver such as a servo motor for driving the door part.

The explanation for the control and advantages of the first embodiment made in the foregoing with reference FIG. 2 can be applied to the control and advantages of the second embodiment by replacing “on-off valve 7” with “on-off valve 107”.

The battery temperature adjustment apparatus 101 does not include the on-off valve 7 for opening and closing the second inflow passage 630, however, it includes the air distribution permitting/inhibiting device which serves as both the on-off valve 107 and the on-off valve 7.

### Other Embodiments

It is a matter of course that various modifications can be made to the above described embodiments as described below.

The air distribution permitting/inhibiting device is not limited to the on-off valve 7 or 107. The air distribution permitting/inhibiting device may be implemented by various components capable of permitting and inhibiting air distribution through one of or both of the discharge passage 620 and the second inflow passage 630.

In the above embodiments, the control device 8 controls the fan device 4 and the on-off valve 7 or 107 in accordance with the temperature data outputted from the temperature sensor 9 or 109. The temperature data used as operation triggers of the fan device 4 and the on-off valve 7 or 107 is data indicating the temperature of the battery cells 3 or data indicating a temperature relevant to the temperature of the battery cells 3. Accordingly, the temperature data may be any data related with the temperature of the battery cells 3. For example, the temperature data may be data indicating the temperature of a specific part of the case 2, the air circulating through the circulation passage 5, the bus bar, the battery case, or a member provided in the circulation passage 5.

The installing position of each of the on-off valves 7 and 107 provided as the air distribution permitting/inhibiting device is not limited to the position shown in the above embodiments.

In each of the above embodiments shown in FIGS. 1 and 3, air is sucked into the fan device 4 through the first inflow passage 54 and the single second inflow passage 630. However, the second inflow passage may be plural in number.

The fan device 4 provided in the case 2 may include an axial fan or a turbo fan instead of the sirrocco fan.

In the above embodiments, the wall surface having the largest surface area of the case 2 is the top plate. However, the wall surface having the largest surface area may be the side plate.

The above explained preferred embodiments are exemplary of the invention of the present application which is described solely by the claims appended below. It should be understood that modifications of the preferred embodiments may be made as would occur to one of skill in the art.

What is claimed is:

1. A battery temperature adjustment apparatus comprising:
a case for housing battery cells;
a fan device disposed in the case for blowing air to cool the battery cells;
a circulation passage formed inside the case, the air blown from the fan device being sucked into the fan device after having circulated through the circulation passage and exchanged heat with the battery cells;
a discharge passage which makes communication between inside and outside of the case, part of the air circulating through the circulation passage being discharged after having exchanged heat with the battery cells;
a first inflow passage which constitutes part of the circulation passage, and through which the air having exchanged heat with the battery cells is sucked into the fan device;
a second inflow passage which makes communication between inside and outside of the case to allow air outside the case to flow therethrough; and
an air distribution permitting/inhibiting device which permits and inhibits air distribution through at least one of the discharge passage and the second inflow passage.

2. The battery temperature adjustment apparatus according to claim 1, wherein the air distribution permitting/inhibiting device inhibits the air distribution when a cell temperature as a temperature of the battery cells or a temperature relevant to the cell temperature is lower than a predetermined air distribution permission temperature.

3. The battery temperature adjustment apparatus according to claim 2, wherein the fan device does not operate until the cell temperature or the temperature relevant to the cell temperature exceeds an operation starting temperature set lower than the air distribution permission temperature.

4. The battery temperature adjustment apparatus according to claim 3, wherein the fan device operates such that an amount of air blown when the cell temperature or the temperature relevant to the cell temperature exceeds the operation starting temperature causing the fan device to start is smaller than an amount of air blown when the air distribution permitting/inhibiting device permits the air distribution.
